(19) United States
(12) Patent Application Publication
(10) Pub. No.: US 2025/0292699 A1
(43) Pub. Date: Sep. 18, 2025

(54) AIRCRAFT TRAINING AID SYSTEMS AND PROCESSES

(71) Applicant: VISIONARY TRAINING RESOURCES, Tampa, FL (US)

(72) Inventors: George Aki NIKOLAIDIS, Brooklyn, NY (US); Darko NIKOLIC, Lakeland, FL (US); Stephen Gabriel JOHNSTON, Houston, TX (US); Jeffrey Ward GOIN, Polk City, FL (US); Jeffrey Lee PIERCE, Redondo Beach, CA (US); Evey Angie CORMICAN, Palm Harbor, FL (US); Naila Victoria Ayala ANGUMBA, Woodbridge, ON (CA)

(21) Appl. No.: 19/225,950

(22) Filed: Jun. 2, 2025

Related U.S. Application Data
(63) Continuation of application No. 17/746,639, filed on May 17, 2022, now Pat. No. 12,322,303.
(60) Provisional application No. 63/210,544, filed on Jun. 15, 2021.

(51) Int. Cl. G09B 9/16; G06F 3/01; G06F 3/04815; G09B 19/00

(52) U.S. Cl. CPC G09B 9/165; G06F 3/013; G06F 3/04815; G09B 19/003

(57) ABSTRACT

The instant application pertains to a mobile aircraft training system comprising a user interface and a virtual flight deck display operably configured to the user interface. A processor is operably linked to the user interface and the virtual flight deck display. The virtual flight deck display is configured to display a three-dimensional representation of an aircraft's controls and indicators from a perspective of an aircraft crew member position. The user interface is configured to identify an interaction between a user and the aircraft's controls and indicators in the three-dimensional representation and configured to communicate said interaction to the processor. The three-dimensional representation is altered based upon said interaction. The processor is configured to provide audio and video feedback to the user via the virtual flight deck display based upon the identified interaction between the user and the aircraft's controls and indicators in the three-dimensional representation.

### CROSS-REFERENCE TO RELATED APPLICATIONS

The present application is a continuation-in-part application of U.S. Ser. No. 17/746,639 filed on May 17, 2022 which application claims priority to U.S. Provisional Application No. 63/210,544 filed on Jun. 15, 2021 which applications are incorporated herein by reference in their entirety.

### FIELD OF THE DISCLOSURE

The present disclosure relates to, for example, systems and processes for training personnel to pilot various aircraft using virtual reality headsets and/or other mobile devices without simulating actual flight. More specifically, the present disclosure relates generally to aircraft and to operating aircraft systems controls, indicators and routine normal and non-normal task mastery.

### BACKGROUND AND SUMMARY

In learning to operate an aircraft, pilots generally go through flight training. Flight training is a course of study that often includes various types of training. For example, pilots may complete distance learning computer-based training, attend classroom lessons, use paper Flight Deck posters and physical Flight Deck mock-ups, Flight Training Devices, Full Flight Simulators, and fly aircraft under the supervision of experienced pilots. Flight training may be performed for new pilots learning to fly an aircraft or for experienced pilots learning to fly a new aircraft.

Learning to operate an aircraft typically begins with learning detailed systems information and proper operating techniques, and memorizing both normal and non-normal, or emergency tasks and procedures by means of various 2D computer and paper media.

Currently, pilots learn flows, procedures, memory items, and other tasks using paper materials, having little to no access to a functional Flight Deck for training and practice. For example, a pilot may use a poster of an aircraft in which the poster is a mock-up of controls in the cockpit of the aircraft taped to a wall, also known as a “paper tiger” or “cardboard bomber”. The pilot may sit in a chair and visualize manipulating the different controls depicted on the poster to perform flows and procedures, also known as “chair flying”.

Sometimes a pilot may use a diagram from the Aircraft Flight Manual that gives guidance on the correct order of tasks to complete a procedure from memory or guidance on how to operate systems controls and read indicators. While referencing the diagram the pilot touches the various controls on the poster taped to the wall and imagines how the aircraft controls may respond.

Research has shown that this type of learning with little to no resemblance to the actual Flight Deck environment may lead to very low information retention, also called ‘far transfer’. In contrast, learning in the actual Flight Deck environment, or as close as possible to the actual Flight Deck may lead to significantly higher retention of the task information, also called ‘near transfer’.

The type of learning described above, and the resulting memorization unrelated to the actual Flight Deck environment, often results in pilots beginning the Flight Simulation and Training Device phase of training without the necessary knowledge to operate the aircraft systems controls and perform tasks efficiently. This can result in pilots needing to re-learn the same information in the context of the actual Flight Deck environment. Of course, this practice can waste expensive and limited Flight Training Device and Full Flight Simulator time. It would be advantageous to have a method and/or a system that achieves better training outcomes in a time and cost-efficient way.

The methods and systems described herein provide training with a very accurate, near real, 3D interactive representation of the aircraft flight deck along with a guided training and evaluation curriculum. In one embodiment, the application pertains to a mobile aircraft training system comprising a user interface and a virtual flight deck display operably configured to the user interface. A processor is operably linked to the user interface and the virtual flight deck display. The virtual flight deck display is configured to display a three-dimensional representation of an aircraft's controls and indicators from a perspective of an aircraft crew member position. The user interface is configured to identify an interaction between a user and the aircraft's controls and indicators in the three-dimensional representation and configured to communicate said interaction to the processor. The three-dimensional representation is altered based upon said interaction. The processor is configured to provide audio and video feedback to the user via the virtual flight deck display based upon the identified interaction between the user and the aircraft's controls and indicators in the three-dimensional representation.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a concept diagram of the interaction between components of the hardware system.

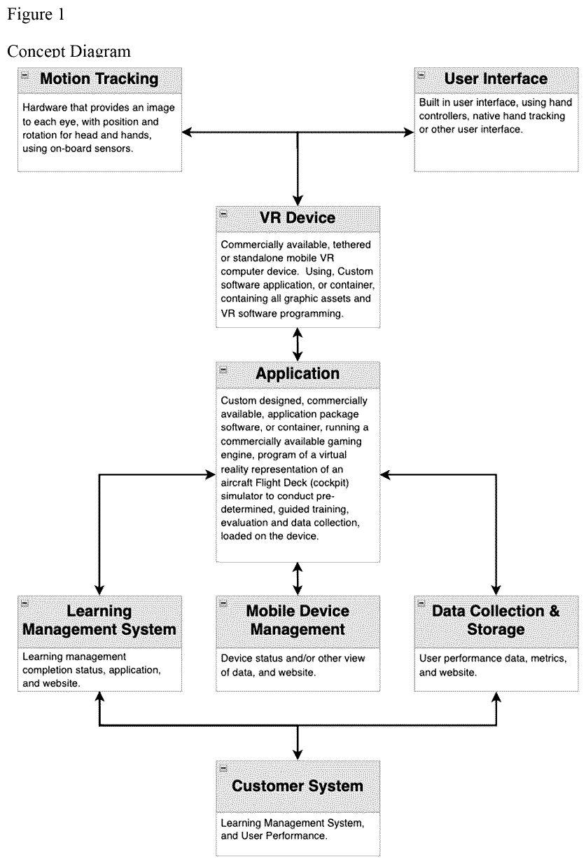

FIG. 2 shows a representative screen shot showing how Training lessons usually must be completed in the specified phase-of-flight order.

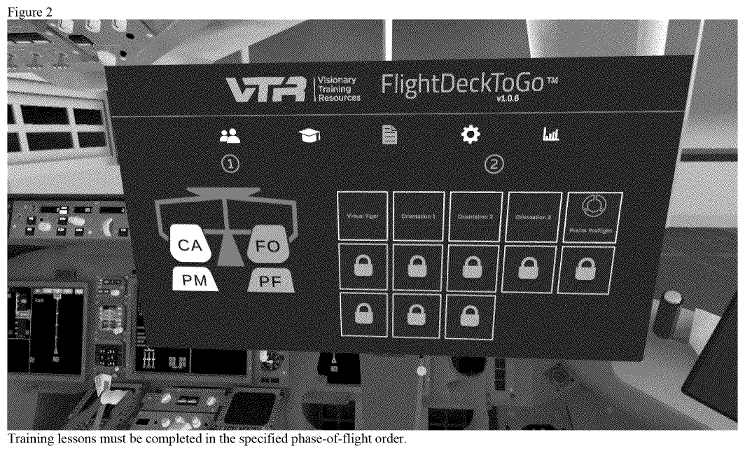

FIG. 3 shows a representative screen shot that shows that once the required training is completed, Training lessons can be repeated without limit for practice.

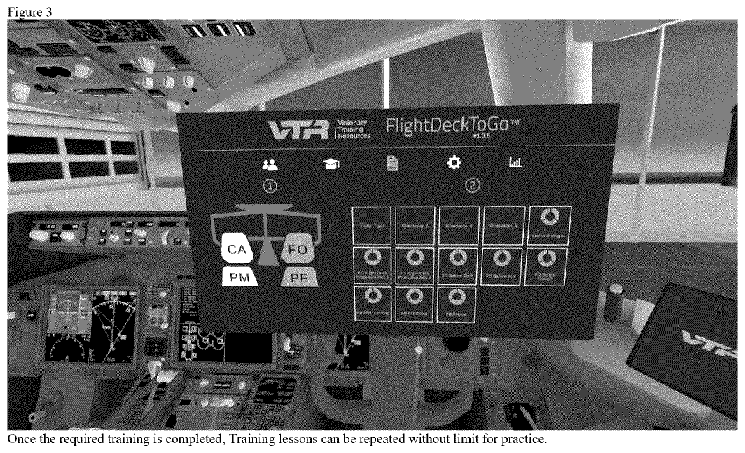

FIG. 4 shows a representative screen shot of Learn (Training 1), Practice (Training 2), Validate (Checking).

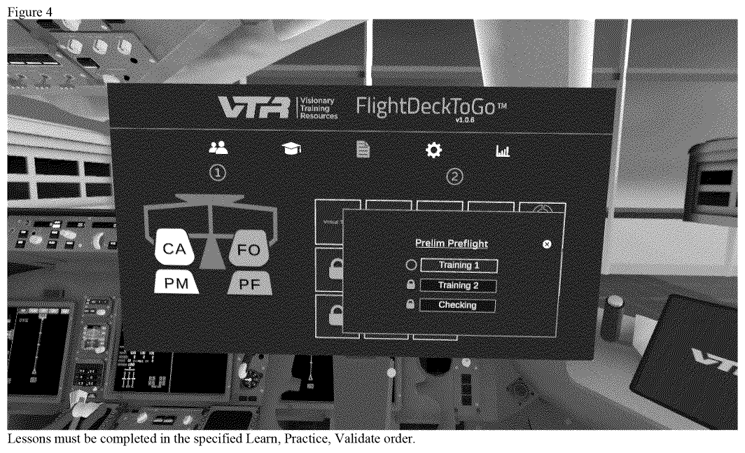

FIG. 5 shows a representative screen shot that Validation events usually must be completed before the user can advance to the next lesson.

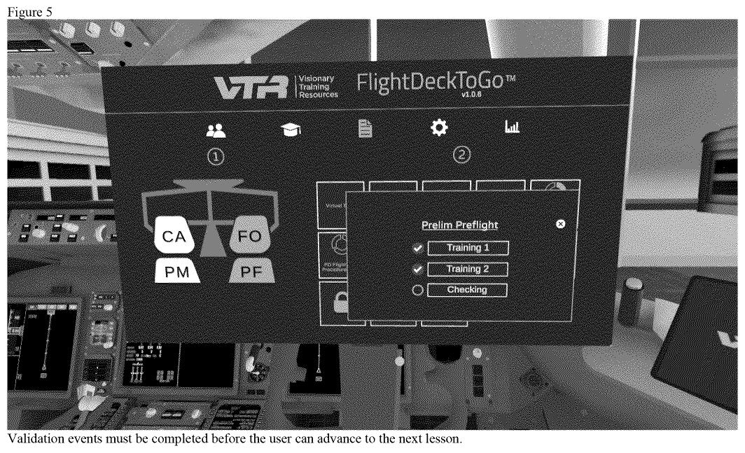

FIG. 6 shows a representative screen shot of UX guided procedure mapping with descriptive voiceover, and systems and environment background sounds that are consistent with a flight deck environment.

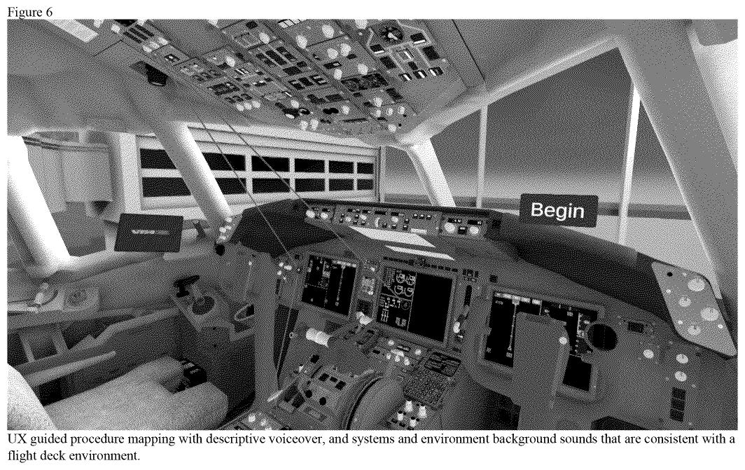

FIG. 7 shows a representative screen shot of UX guided procedure mapping with Sequence numbers from customized flow.

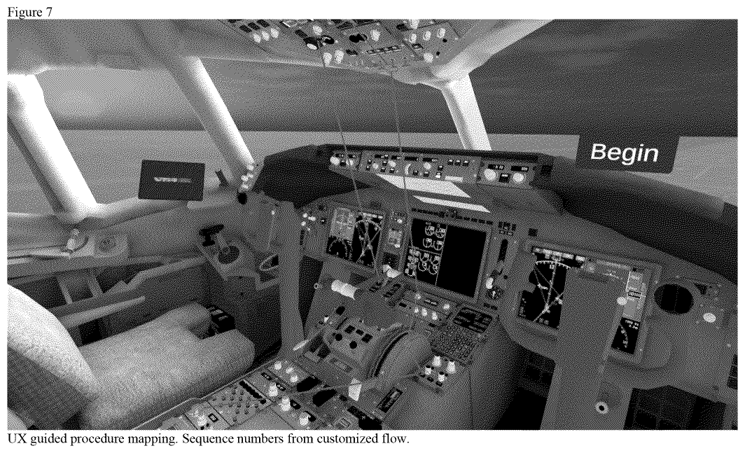

FIG. 8 shows a representative screen shot of individual step tutorial cues including visual cues, text and audio guidance.

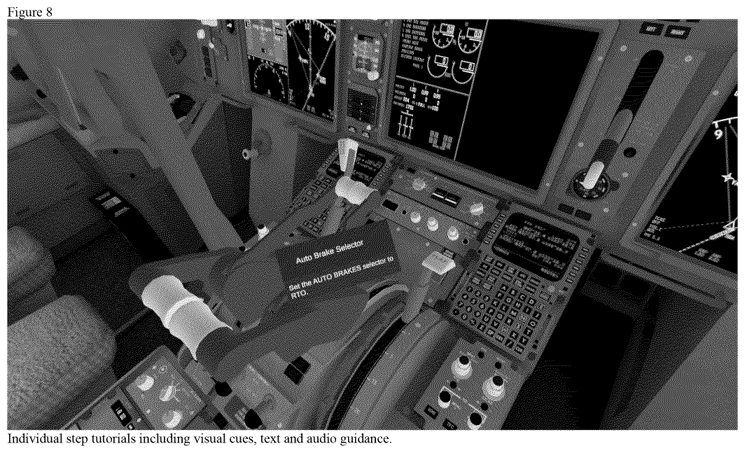

FIG. 9 shows a representative screen shot of UX guided eye tracking verification steps (magenta).

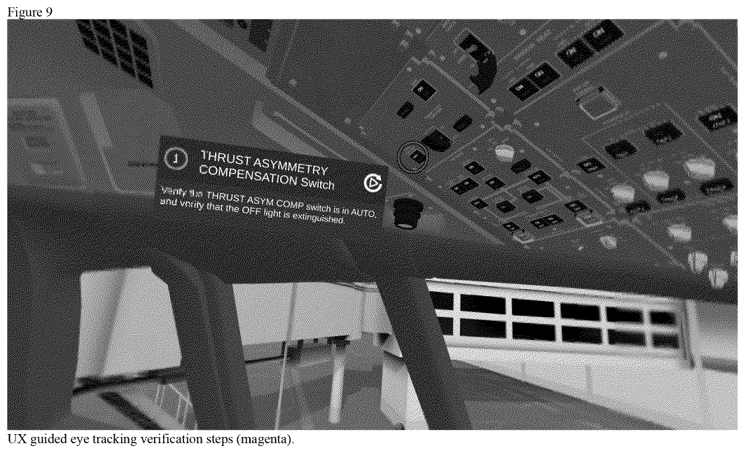

FIG. 10 shows a representative screen shot of an eye tracking focal point cue when hardware detects the pilot is looking at the target (white).

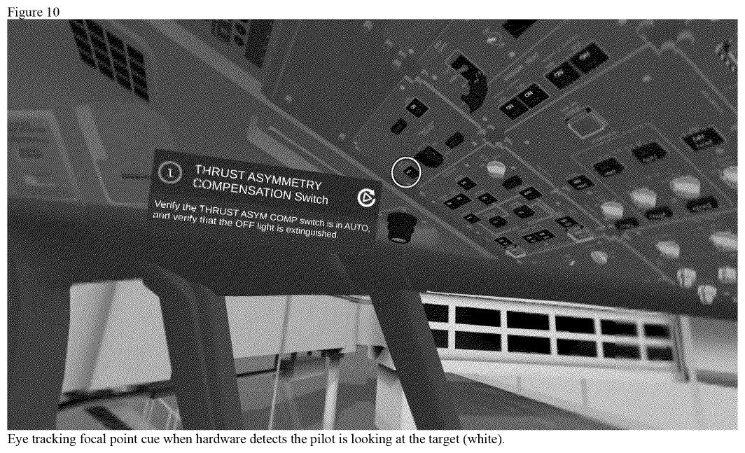

FIG. 11 shows a representative screen shot of an eye tracking focal point cue when user completes the verification task (green).

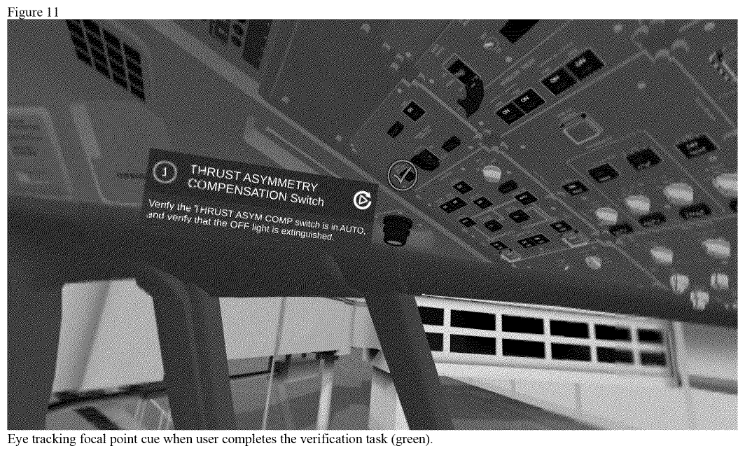

FIG. 12 shows a representative screen shot of an eye tracking step that takes the shape of a circular gauge when the hardware detects the pilot looking at the target (white).

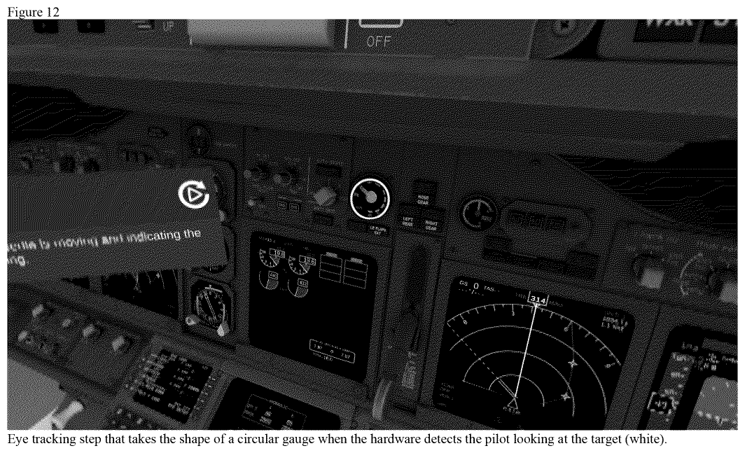

FIG. 13 shows a representative screen shot of an eye tracking step that takes the shape of the panel.

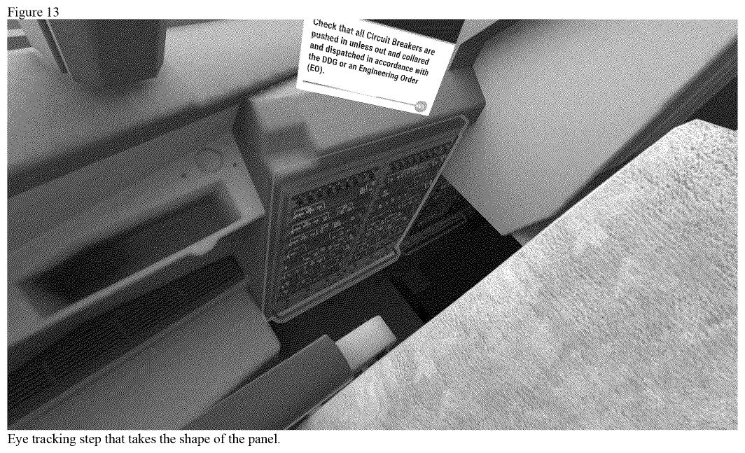

FIG. 14 shows a representative screen shot of selectable, on demand, weather and flight documents.

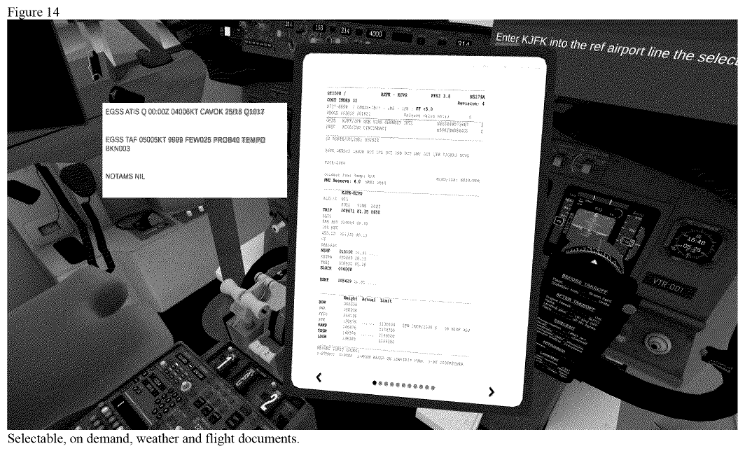

FIG. 15 shows a representative screen shot of UX guided procedure mapping for complex sequences.

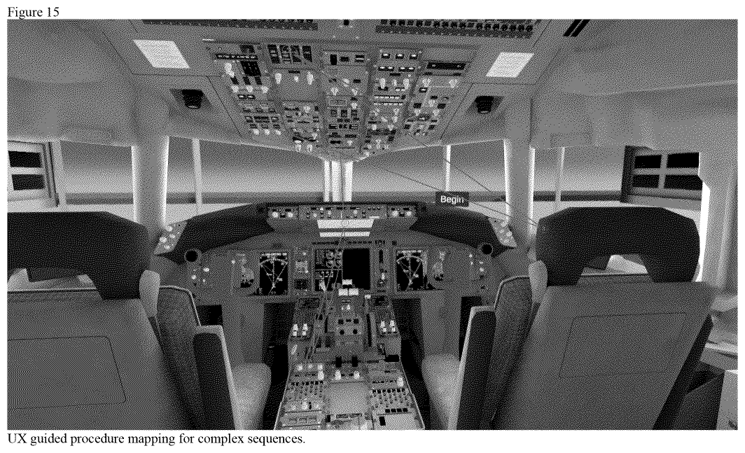

FIG. 16 shows a representative screen shot of UX guided procedure mapping for complex sequences that are split into two lessons (showing part 1).

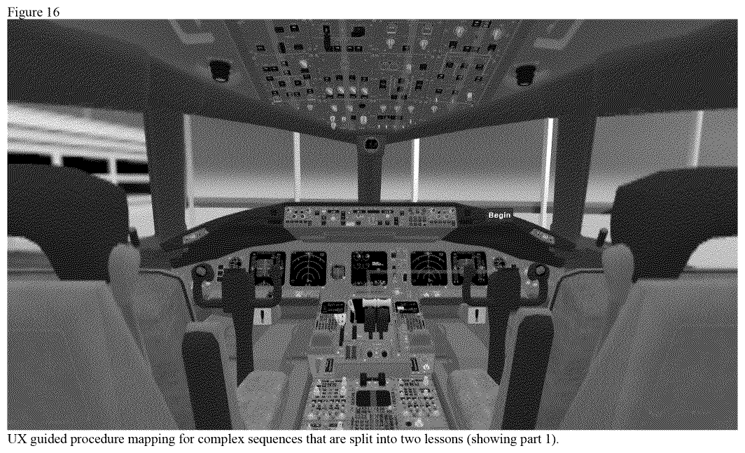

FIG. 17 shows a representative screen shot of UX guided procedure mapping for complex sequences that are split into two lessons (showing part 2).

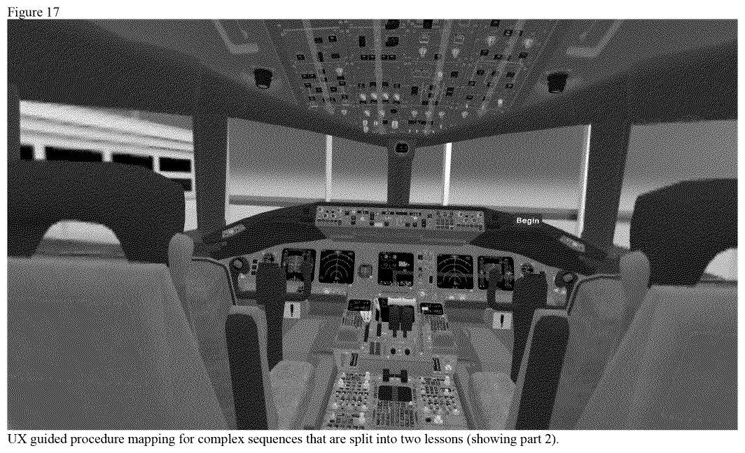

FIG. 18 shows a representative screen shot showing varying levels of tutorials are progressively provided that include text, virtual instructor voice over, and UX for task identification.

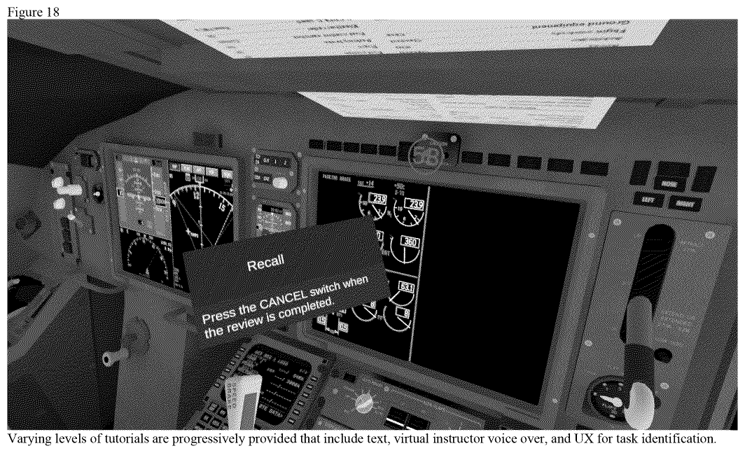

FIG. 19 shows a representative screen shot of UX guided spatial Orientation training lessons.

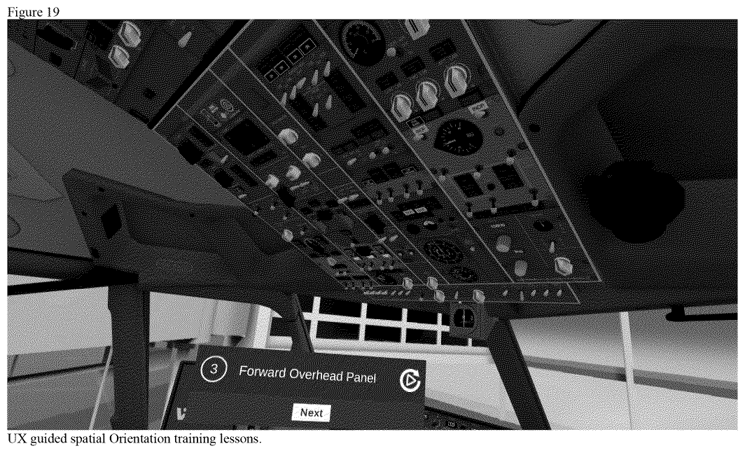

FIG. 20 shows a representative screen shot of Systems training lessons.

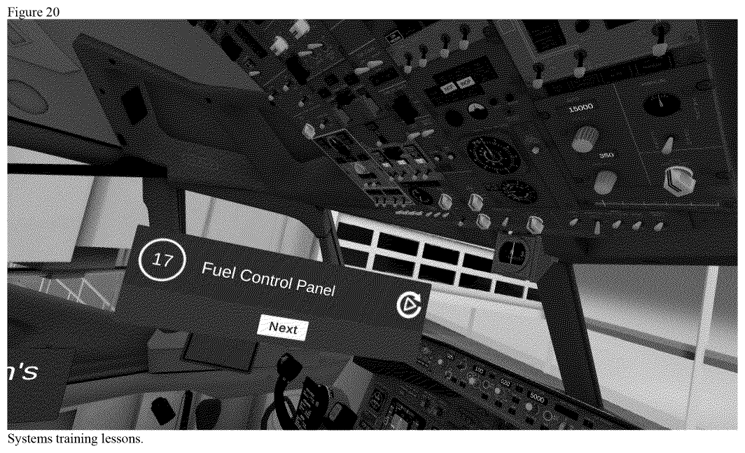

FIG. 21 shows a representative screen shot how pilots can be given, or select, progressive system descriptions with UX. Fuel panel manipulation instantly shows the system diagram changes.

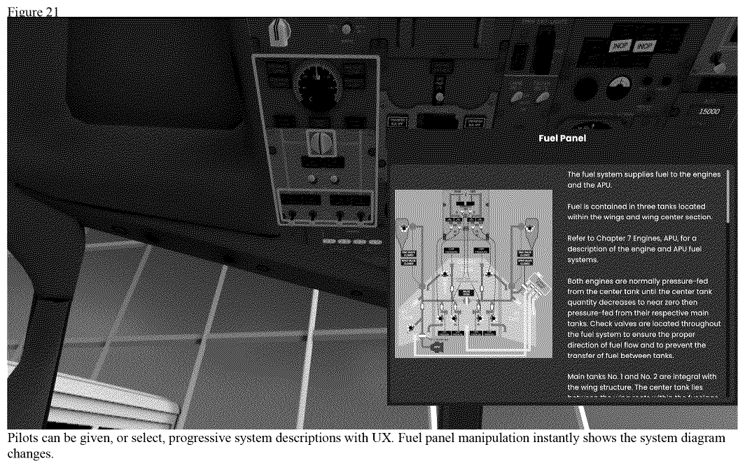

FIG. 22 shows a representative screen shot of Training lesson progress step tracking and completion monitoring once all steps ate completed.

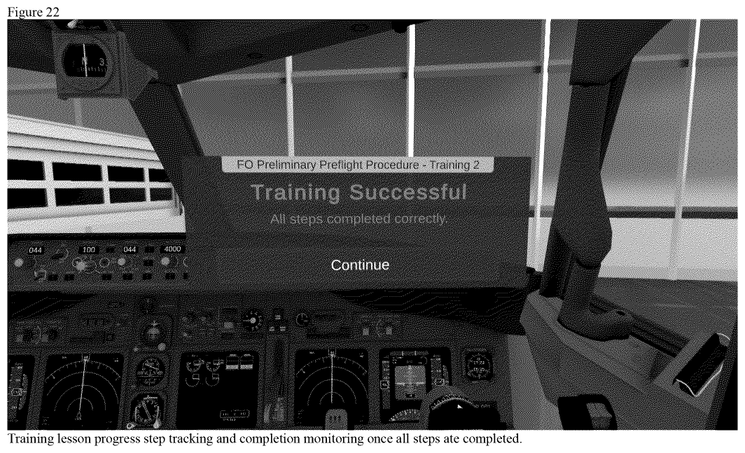

FIG. 23 shows a representative screen shot of how to monitor progress and evaluate overview of all steps in the lesson includes completed steps, lookback, and/or hints.

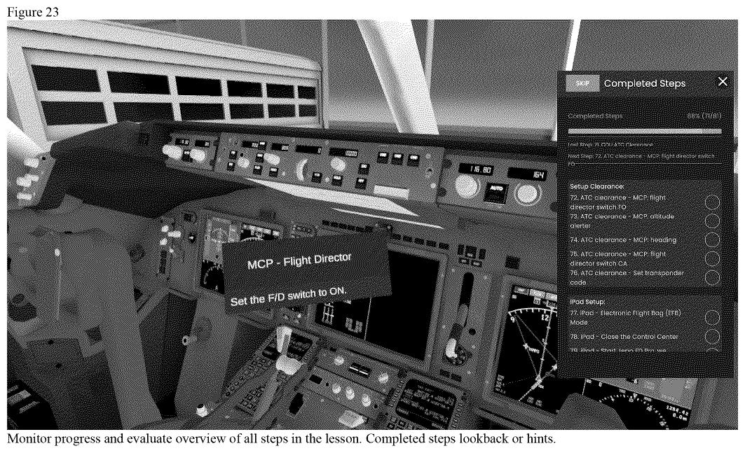

FIG. 24 shows a representative screen shot how validation mode provides instant review recommendation with incorrect control selection.

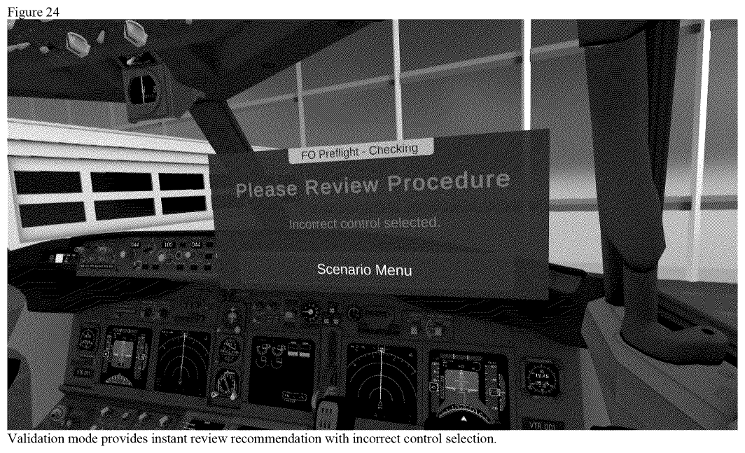

FIG. 25 shows a representative screen shot of three selectable crew duty positions and showing First Officer seat.

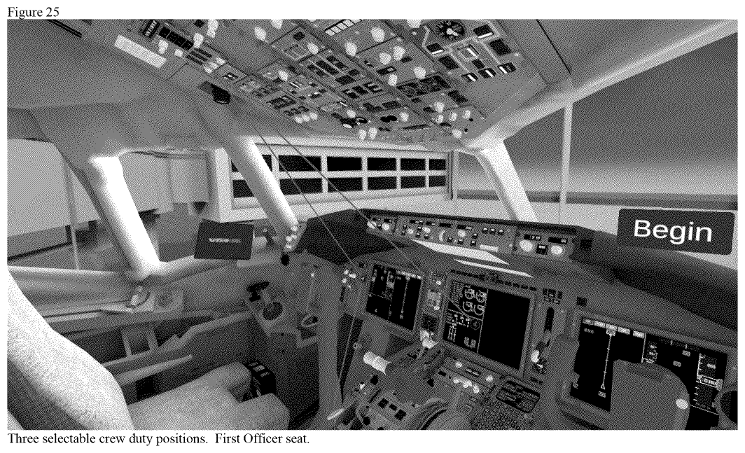

FIG. 26 shows a representative screen shot of three selectable crew duty positions and showing Captains seat.

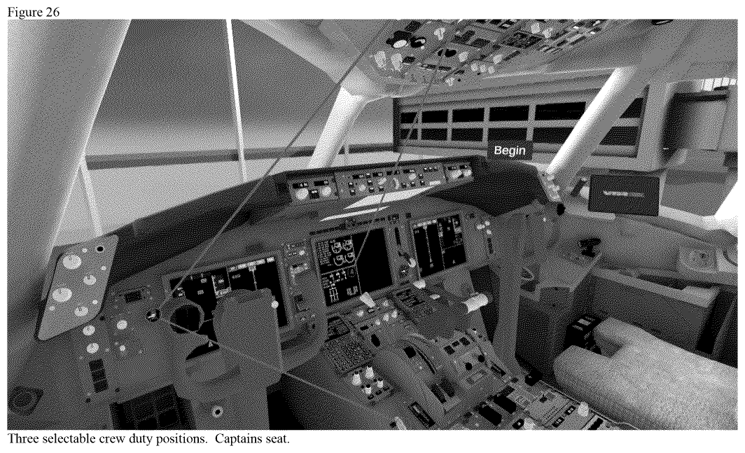

FIG. 27 shows a representative screen shot of three selectable crew duty positions and showing Observer seat.

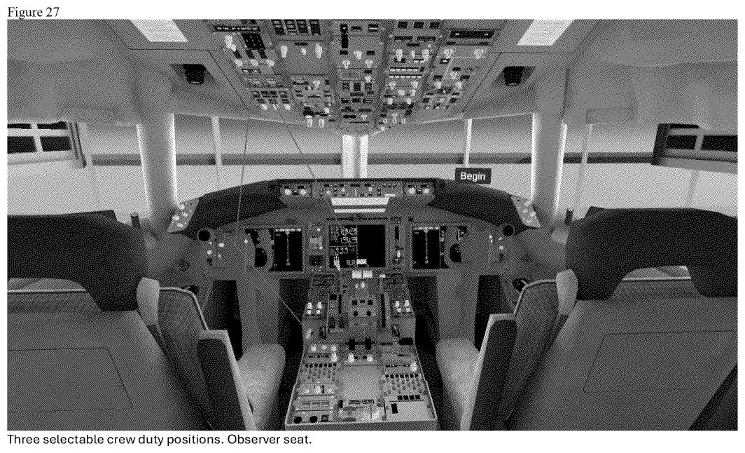

FIG. 28 shows a representation of hardware deployment and runtime.

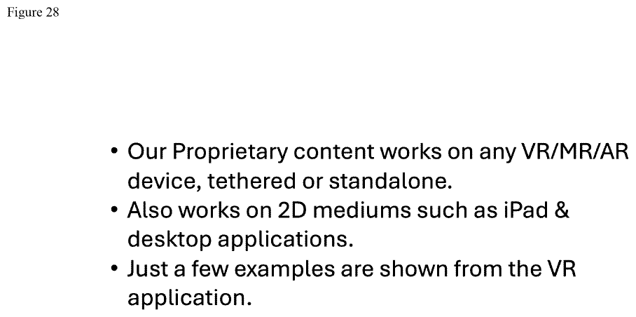

FIG. 29 shows a representative screen shot of standalone VR headset.

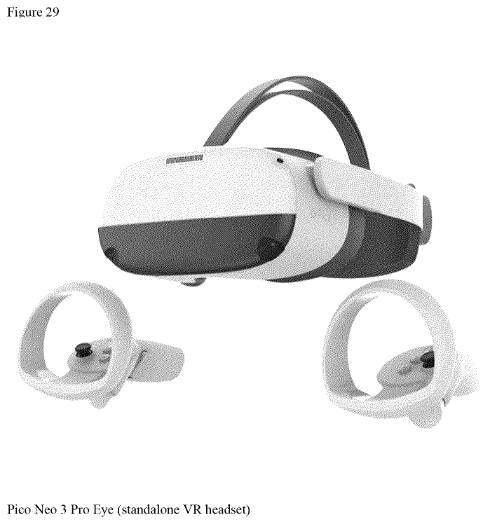

FIG. 30 shows a representative screen shot of a tethered MR headset.

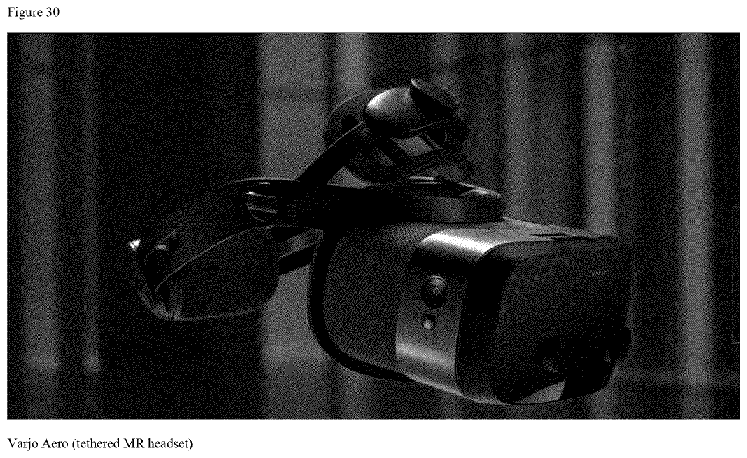

FIG. 31 shows a representative screen shot of a standalone MR headset.

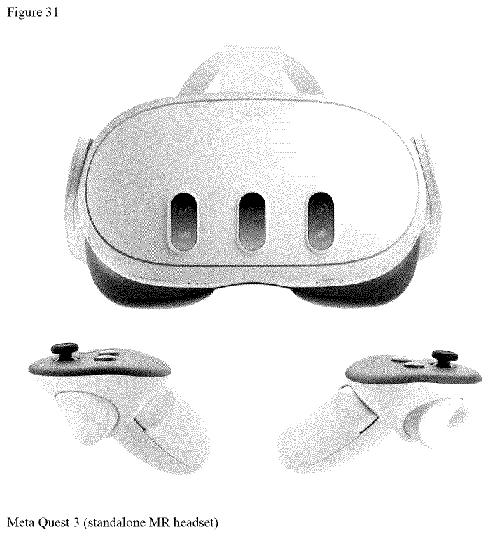

FIG. 32 shows a timeline diagram illustrating dynamic event injection, time-scaling in Learn Mode, and subsequent resume to real-time operation.

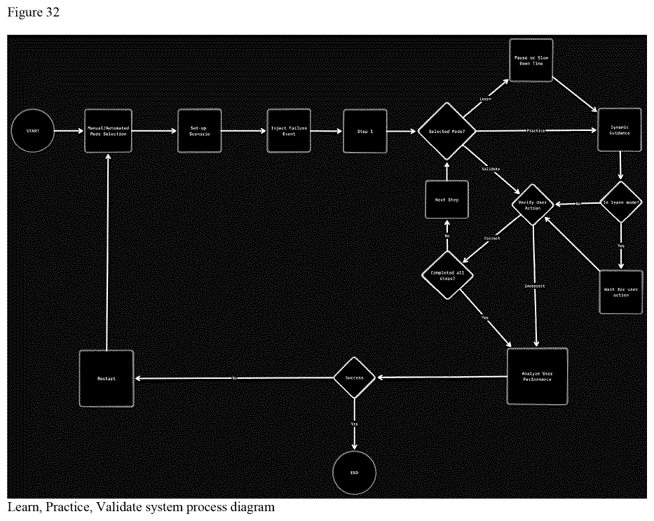

FIG. 33 shows data collection and analysis for microstate measurement and adaptive task adjustment.

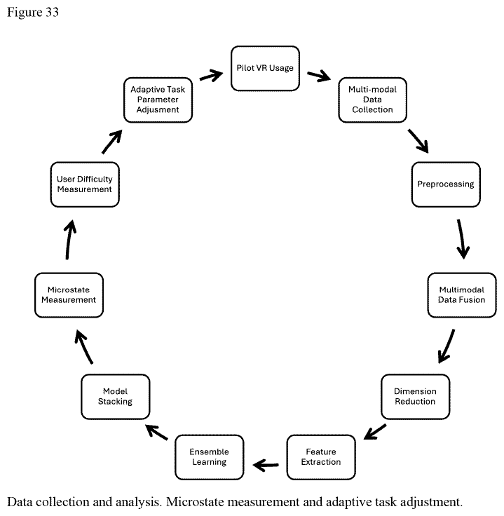

### DETAILED DESCRIPTION

The following description of embodiments provides non-limiting representative examples to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

In one embodiment the present application pertains to a mobile aircraft training system. The system may be characterized as a training program and not as a flight simulation training device under 14 CFR § 1.1 as it exists as of the provisional and utility filing date because the systems herein do not simulate flight in some embodiments. That is, in some embodiments the training provided herein does not train on flight, does not have a navigation database, does not allow manual flight control, is not dynamic and therefore may not react like a real airplane to change flight path as in a full flight simulator. Instead, in some embodiments the training systems described herein may pertain to static, pre-programmed sequences for pre-flight, taxi, and in-inflight normal and non-normal scenarios. More specifically, in some embodiments any in-flight procedure training herein may be a sequential procedure wherein a proper user selection takes the user to another procedure in the sequence whereas an incorrect user selection may not advance the user. Thus, in some embodiments there is not manual control of an airplane as in a full flight simulator.

The system is generally comprised of at least one user interface, at least one virtual flight deck display, and at least one processer wherein the aforementioned components are operably linked such that remote training on various aircraft operations and functions may be conducted. While the user interface, virtual flight deck display, and processer may be on separate devices in one embodiment they are all contained on a single mobile device such that training may be conducted on the device whether or not the device is connected to a communications network (wireless or wired). The type of mobile device employed in the present system is not particularly limited and includes, for example, devices such as a virtual reality headset, a laptop computer, a tablet computer, or a mobile phone.

The system typically has at least one user interface but may have a second user interface or even a third (or more) user interface. In this manner, the system may allow multiple users to interact to simulate, for example, roles of a captain, first officer, second officer, and/or an instructor. Each user interface may be located remote from the other although in some embodiments a single user interface may be configured to support multiple users.

The user interface is operably connected to a virtual flight deck display. The virtual flight deck display is typically on a display of a mobile device and configured to display a three-dimensional representation of an aircraft's controls and indicators. These controls and indicators vary depending upon the specific aircraft. Thus, in some embodiments the system may comprise one, two, or three or even more different virtual flight decks wherein each virtual flight deck corresponds to a different type of aircraft, e.g., Boeing 737, 747, 777, 787, Airbus A318-A320 and A380. In this manner a user may select the specific aircraft/flight deck upon which the user desires training.

Advantageously, in some embodiments the systems and methods may be customizable by a user for a specific airline, a type of aircraft, a crew member perspective, a crew member's responsibilities, or any combination thereof, i.e., one, two, three, or all of the aforementioned customizations. That is, even though two airlines fly a 737, each airline's procedures may differ. The system and methods described here allow for a user to train on a specific airline's procedures whether that airline is a commercial airline, military, or private airline transportation. The same is true for crew member perspective and responsibilities each of which may change depending upon the aircraft and/or airline. The systems and methods here allow the user to select the appropriate training desired which training is uniquely customizable.

Typically, the three-dimensional representation of an aircraft's controls and indicators are displayed from a typical perspective of an aircraft crew member position, e.g, captain, first officer, jump seat, or in some embodiments from a perspective between a captain and first officer so that the training is useful for both captain and first officer positions. In some embodiments the virtual flight deck display offers six degrees of freedom such that there are six directions in which the user's head can move in three-dimensional space, i.e., rolling, pitching, yawing, elevating, strafing, and surging.

The perspective of an aircraft crew member's position to the virtual flight deck display may vary but in some embodiments the relative position is fixed between the user and the virtual flight deck. Fixing the virtual flight deck display to a physical space surrounding the user may be accomplished in any convenient manner. In some embodiments one, two, three, four, five, six, seven, or even more cameras may be employed in fixing the virtual flight deck display to a physical space surrounding the user. Such cameras may be of any convenient type and can be affixed to or embedded in a mobile device used for display, e.g., virtual reality headset.

The user interface may be configured to identify an interaction between a user and the aircraft's controls and indicators in the three-dimensional representation and to communicate said interaction to the processor. In this manner the three-dimensional representation is altered based upon said interaction. For example, a user may use his or her hand to move a virtually displayed switch or control from off to on and the user interface identifies and communicates the movement to the processor which in turn alters the display to show the switch or control moved from off to on. In other embodiments the interaction and communication may be related to and/or include the user's hand movement in the three-dimensional representation, a headset movement by the user, a controller movement by the user, e.g., button press, a user's eye movement in the three-dimensional representation, or any combination thereof. The interaction and communication may be accomplished in any convenient manner so long as the user's interaction with the virtual flight deck display is generally accurately represented.

The processor is configured to provide audio and video feedback to the user based upon the identified interaction between the user and the aircraft's controls and indicators in the three-dimensional representation. Such feedback is typically provided via the virtual flight deck display based upon the identified interaction between the user and the aircraft's controls and indicators in the three-dimensional representation. For example, if the identified reaction was a proper reaction an indication of such may be made via video, audio, or both on the display. Similarly, if the identified reaction was not proper, then there may be no indication or alternatively there could be an indication to notify the user that it was improper via video, audio, or both on the display.

The identified interaction between a user and the aircraft's controls and indicators in the three-dimensional representation is not particularly limited and may be, for example, movement of a user's body part, the user's movement of a controller or joystick, and/or any combination thereof. The identified interaction between a user and the aircraft's controls and indicators in the three-dimensional representation may comprise a user's hand or arm movement, a user's eye movement, a user's movement of a controller or joystick operably linked to the system, or any combination thereof.

If desired memory may be included in the processor or separate and is operably connected to the system. The memory may be configured to record the interaction or series of interactions between the user and the aircraft's controls and indicators. In this manner an evaluation may be provided to the user based on the user's proper and/or improper recorded interactions. Unlike full flight simulators that use a briefing package as part of an evaluation, the instant system may contemplate a pass/fail evaluation and/or be enabled for adaptive learning and in some embodiments the system may be configured for adaptive learning conducted in real time.

The system may further be configured to collect, store, and analyze data relating to a user's eye movement to provide an evaluation to the user based upon the user's eye movement. Additionally or alternatively, the system may be configured to use real-time eye tracking and visual and audio directions to train a user or users specific gaze actions to complete visual only tasks as required as part of normal, non-normal, and/or emergency procedures.

In addition to eye movement, the system may be configured to collect, store, and/or analyze data related to a user's hand movement, headset movement, controller movement, system interactions, or any combination thereof. The data collection, storage, and/or analysis may be employed to, for example, provide an evaluation to the user or for other purposes. Such other purposes are not particularly limited. In one embodiment, at least a portion of data collected, stored, and/or analyzed may be used to measure subtle psychological microstates (e.g., fatigue, cognitive load, task focus, confusion, and/or stress). For example, the system may employ such processes as, for example, multimodal data fusion modeling. In this manner, validated approaches may be used to measure psychological microstates in real time. These approaches may be enhanced, if desired, through machine learning approaches for denoising, data augmentation, dimension reduction, ensemble learning, and data fusion to enhance the predictive performance and reliability of microstate measurements.

The system may be configured to accommodate a second user (or even a third) interface operably connected to the user interface, the processor, and the virtual flight deck display. In such cases, the system may also be configured to collect, store, and analyze data relating to a second and/or third user's eye movement, hand movement, headset movement, controller movement, system interactions, or any combination thereof to, for example, provide an evaluation to the second or third user. Other potential uses of a second and/or third user interface may be to allow the system to provide crew coordination training, crew resource management training, threat and error management, or any combination thereof. The user interface and a second user interface may also be configured to, for example, simulate joint operation of a captain and a first officer and/or provide a guided tutorial for interaction between a captain and a first officer.

While eye movement monitoring or tracking, hand movement, headset movement, or controller movement may be detected in any convenient manner in some embodiments a camera or other eye movement or general movement sensor may be located on the device housing the user interface and/or other system components. For example, an eye movement or other movement sensor may be placed inside a virtual reality headset and configured to transmit data concerning eye movements in relation to the aircraft's controls and indicators and/or interaction or series of interactions between the user and the aircraft's controls and indicators. Hand movement, headset movement, or controller movement may be detected with one or more sensors inside or outside a virtual reality headset or other device. Such sensor(s) may be configured to collect, store, and transmit data concerning movement in relation to the aircraft's controls and indicators and/or interaction or series of interactions between the user and the aircraft's controls and indicators. The user can then potentially be evaluated based upon proper eye movement, hand movement, headset movement, or controller movement to the proper aircraft control at the proper time. Many routine, critical tasks that pilots must complete do not require physical interaction with the aircraft systems controls, but visual verification that certain tasks result in very specific indications and visual only checks of systems indications. Therefore, as described above in some embodiments eye tracking hardware and software are integrated and used to train and validate visual only task completion by monitoring, for example, a user's eye movement. Tracking of hand movement, headset movement, or controller movement may also be integrated and used to train and validate task completion.

Dynamic Event Injection. In certain embodiments, the training system includes scenarios configured to inject a non-normal event at a dynamically selected flight parameter set (e.g., altitude, airspeed, vertical speed, heading, elapsed mission time, or flight-phase identifier). The engine may (i) select the parameter set pseudo-randomly within predefined bounds, (ii) accept manual selection from an instructor console, or (iii) follow a predetermined schedule read from a scenario file. Trainees may not be informed of the impending injection, thereby emulating real-world surprise-and-startle conditions.

Context-Dependent Procedure Generator. Upon injection, a rule generates an expected action sequence by evaluating the real-time aircraft-state vector and selecting a corresponding procedure variant from a library. For example, an engine-fire procedure initiated above V1 but below 400 ft AGL requires a different checklist and action ordering than one initiated at cruise. If desired, the system may further comprise a second user (or even a third) interface operably connected to the user interface, the processor, and the virtual flight deck display. In this manner the training system may provide training to a captain, first officer, and/or a third user in aspects such as crew coordination training, crew resource management training, threat and error management, or any combination thereof. The first, second, and/or third user can interact with the virtual flight deck display, with each other, and/or potentially with a control tower, simultaneously to simulate more realistic crew interaction and duties of each crew member within a cockpit. The second and/or third user interface may be similarly connected to the system and have similar features as described above for the user interface. That is, the second and/or third user's interactions or series of interactions with the three-dimensional representation of the aircraft's controls and indicators may be used to alter the three-dimensional representation, audio or video feedback may be provided to the second and/or third user, and the interactions may be recorded for evaluation purposes or otherwise. Similarly, the system may be configured such that a second and/or third user's eye movement may be tracked and used for evaluation, training, or other purposes.

The content of the training system may vary widely depending upon the skill level of the user, the virtual flight deck controls, and desired outcome. In general, training content may be loaded locally on the device used for the system, e.g., virtual reality headset, in the form of an app or a program. Alternatively, training content can be streamed wirelessly or over a wire to the desired device and in some embodiments a remote content management program may be employed to remotely add, delete, or alter training content on a device. The training content may be developed using custom software and/or commercially available software such as UNITY™ or UNREAL ENGINE™ to program application containers or packages.

In some embodiments, training content involves configuring the virtual flight deck display to display a guided sequence of two or more proper interactions between the user and the aircraft's controls and indicators in the three-dimensional representation. Of course, the same or similar content may be provided to a second or third user if the system is configured for additional users. In some embodiments the user may complete each interaction and obtain immediate feedback after each interaction. In other embodiments the user may complete the entire sequence before receiving feedback. The displayed guided sequence may comprise audio, video, or both.

In some embodiments, the system may comprise help on demand whereby a user can request assistance or hints as to the proper response to, for example, a particular scenario or guided sequence. In some embodiments, the system may be configured such that a user may select a speed of a scenario and/or pre-programmed sequences for pre-flight, taxi, and/or in-inflight normal and/or non-normal scenarios. This allows a beginning user to slow the scenario or sequence allowing more time for a proper response while a more advanced user may increase the speed requiring more rapid responses.

The pre-programmed sequences are not particularly limited and may also be customizable by a user for an airline, a type of aircraft, a crew member perspective, a crew member's responsibilities, or any combination thereof. Representative pre-programmed sequences for pre-flight, taxi, and in-inflight normal and non-normal scenarios may comprise walk-around, departure, approach, arrival, rejected take-off, wind shear, unreliable air speed, or any combination thereof. Thus, in some embodiments the virtual flight deck display referred to herein may include at least a portion of the exterior the plane during, for example, the sequences involving the walk-around inspection and the like.

If desired, the training content may comprise the virtual flight deck display providing audio and/or video instruction on proper interaction between a user and the aircraft's controls and indicators in the three-dimensional representation. In some embodiments the system may comprise a video and audio link from a full flight simulator. In this manner a user may view recorded full flight simulator sessions to prepare for such a session.

The training content may be structured in any convenient manner. For example, training modules requiring various levels of expertise may be provided such that they must be completed in a specified order before the next module is unlocked. For example, in some embodiments “737 flight deck orientation module 1” must be successfully completed and then “first officer pre-flight procedure module 2” and then “before taxi procedure module 3”. Once successfully completed training modules may be available for practice.

Lessons within each module may be provided in a specific order, e.g., a structured virtual curriculum. The lessons may include, among other items, a unique user experience design (UX) to guide procedure mapping which in some embodiments includes spatial orientation training. In some embodiments the levels of tutorial (text, instructor voice, and/or UX task identification on virtual flight deck display) are progressively provided to the user or withdrawn depending upon a user's progress. That is, the content provided to the user may adapt in real time to the user's abilities in order to most effectively train the user. The training progress is nearly continuously monitored in some aspects. Progress evaluation checks may be included to review procedures or scenarios within a chapter or even within a lesson.

The system described above may be configured to link to one or more observers located locally or remotely. Such observers may view the training in real time for evaluation or learning purposes. The observer link or links may include functionality for chat, questions, or comments if desired.

The attached figures show representative flow diagrams, screen shots, and/or further explanation of certain potential embodiments.

### Embodiments

1. A mobile aircraft training system comprising:
a user interface;
a virtual flight deck display operably configured to the user interface; and
a processor operably linked to the user interface and the virtual flight deck display;
wherein the virtual flight deck display is configured to display a three-dimensional representation of an aircraft's controls and indicators from a perspective of an aircraft crew member position;

wherein the user interface is configured to identify an interaction between a user and the aircraft's controls and indicators in the three-dimensional representation and to communicate said interaction to the processor and wherein the three-dimensional representation is altered based upon said interaction; and
wherein the processor is configured to provide audio and video feedback to the user via the virtual flight deck display based upon the identified interaction between the user and the aircraft's controls and indicators in the three-dimensional representation;
wherein the identified interaction between the user and the aircraft's controls and indicators in the three-dimensional representation comprises the user's hand movement in the three-dimensional representation, a headset movement by the user, a controller movement by the user, a user's eye movement in the three-dimensional representation, or any combination thereof;
wherein the mobile aircraft training system comprises pre-programmed sequences for pre-flight, taxi, and in-inflight normal and non-normal scenarios wherein the system is customizable by a user for an airline, a type of aircraft, a crew member perspective, a crew member's responsibilities, or any combination thereof.

2. The mobile aircraft training system of embodiment 1 wherein the controller movement by the user comprises a button press by the user.

3. The mobile aircraft training system of embodiment 1 wherein the system is customizable for two more of an airline, a type of aircraft, a crew member perspective, or a crew member's responsibilities.

4. The mobile aircraft training system of embodiment 1 wherein the system is customizable for three or more of an airline, a type of aircraft, a crew member perspective, or a crew member's responsibilities.

5. The mobile aircraft training system of embodiment 1 wherein the system is customizable for an airline, a type of aircraft, a crew member perspective, and a crew member's responsibilities.

6. The mobile aircraft training system of embodiment 1 wherein the system is configured to collect, store, and analyze data relating to a user's eye movement, hand movement, headset movement, controller movement, system interactions, or any combination thereof to provide an evaluation to the user.

7. The mobile aircraft training system of embodiment 1 wherein the system further comprises a second user interface operably connected to the user interface, the processor, and the virtual flight deck display wherein the system is configured to collect, store, and analyze data relating to a second user's eye movement, hand movement, headset movement, controller movement, system interactions, or any combination thereof to provide an evaluation to the second user.

8. The mobile aircraft training system of embodiment 1 wherein the system further comprises a second user interface operably connected to the user interface, the processor, and the virtual flight deck display such that the training system provides crew coordination training, crew resource management training, threat and error management, or any combination thereof.

9. The mobile aircraft training system of embodiment 1 wherein the system further comprises a second user interface operably connected to the user interface, the processor, and the virtual flight deck display and wherein the user interface and second user interface are configured to simulate joint operation of a captain and a first officer.

10. The mobile aircraft training system of embodiment 1 wherein the system further comprises a guided tutorial for interaction between a captain and a first officer.

11. The mobile aircraft training system of embodiment 1 wherein the system further comprises a help on demand.

12. The mobile aircraft training system of embodiment 1 wherein a user may select a speed of the pre-programmed sequences for pre-flight, taxi, and in-inflight normal and non-normal scenarios.

13. The mobile aircraft training system of embodiment 1 wherein the pre-programmed sequences for pre-flight, taxi, and in-inflight normal and non-normal scenarios comprise walk-around, departure, approach, arrival, rejected take-off, wind shear, unreliable air speed, or any combination thereof.

14. The mobile aircraft training system of embodiment 6 wherein the system is configured to employ at least a portion of the data to measure one or more of a user's psychological microstates in real time.

15. The mobile aircraft training system of embodiment 14 wherein the system is configured through machine learning to measure, and improve the reliability and accuracy of the measurement of psychological microstates.

16. The mobile aircraft training system of embodiment 15 wherein the system is configured through machine learning to reduce noise, augment data, reduce data dimensionality, fuse multi-modal data, or any combination thereof in order to measure psychological microstates.

17. The mobile aircraft training system of embodiment 1, wherein one or more of the scenarios is configured to inject a non-normal event at a flight parameter and flight-phase, the selection being (i) random, (ii) instructor-defined, (iii) schedule-based, (iv) machine learning based adaptive, or (v) any combination thereof.

18. The mobile aircraft training system of embodiment 1, wherein the processor is further configured to modify a simulation timebase by pausing, accelerating, or decelerating scenario time until a detected user interaction matches a required interaction.

19. The mobile aircraft training system of embodiment 1, wherein the processor supports at least three operating modes comprising: (a) a learn mode with time-base modification and guidance overlays; (b) a practice mode with guidance overlays and real-time operation; and (c) a validate mode with real-time operation and no guidance overlays.

20. The mobile aircraft training system of embodiment 18, wherein the required plurality of user interactions changes in real time based on at least one prior user interaction to implement branching scenario logic.

21. A mobile device comprising the mobile aircraft training system of embodiment 1.

22. A method of training a pilot comprising:
providing a user with a mobile device selected from a virtual reality headset, a laptop computer, a tablet computer, or a mobile phone;
wherein the mobile device comprises a virtual flight deck display, a user interface, a processor, and an aircraft training system;
wherein the aircraft training system comprises pre-programmed sequences for pre-flight, taxi, and in-inflight normal and non-normal scenarios for two or more airlines, two or more types of aircraft, two or more crew member perspectives, two or more crew member's responsibilities, or any combination thereof;
prompting the user to select from a learn mode, a practice mode, or a validate mode;
prompting the user to select a scenario from the pre-programmed sequences for pre-flight, taxi, and in-inflight normal and non-normal scenarios;
running the selected scenario; and
collecting, storing, and analyzing data relating to the user's eye movement, hand movement, headset movement, controller movement, system interactions, or any combination thereof.

23. The method of embodiment 22 which further comprises providing an evaluation to the user based on the data.

24. The method of embodiment 23 which further comprises employing at least a portion of the data to measure one or more of a user's psychological microstates in real time.

25. The method of embodiment 24 wherein the one or more psychological microstates comprise fatigue, cognitive load, task focus, confusion, stress, or any combination thereof.

26. The method of embodiment 24 which further comprising employing one or more machine learning related approaches of preprocessing, multimodal data fusion, dimension reduction, feature extraction, ensemble learning, and model stacking to enhance predictive performance of microstate measurements, reliability of microstate measurements, predictive performance of user difficulty measurement, reliability user difficulty measurements, or any combination thereof.

27. A method of training a pilot comprising:
(1) providing a user with a mobile device selected from a virtual reality headset, a laptop computer, a tablet computer, or a mobile phone;
wherein the mobile device comprises a virtual flight deck display, a user interface, a processor, and an aircraft training system;
wherein the aircraft training system comprises pre-programmed sequences for pre-flight, taxi, and in-inflight normal and non-normal scenarios for two or more airlines, two or more types of aircraft, two or more crew member perspectives, two or more crew member's responsibilities, or any combination thereof;
(2) prompting the user to select a scenario or injecting a system generated scenario to the user;
(3) running the user selected or system generated scenario; and
(4) collecting, storing, and analyzing data relating to the user's eye movement, hand movement, headset movement, controller movement, system interactions, or any combination thereof related to the selected or injected scenario.

28. The method of embodiment 27 wherein the scenario selected by the user comprises pre-programmed sequences for pre-flight, taxi, and in-inflight normal and non-normal scenarios.

29. The method of embodiment 27 wherein the system generated scenario comprises pre-programmed sequences for pre-flight, taxi, and in-inflight normal and non-normal scenarios.

30. The method of embodiment 27 wherein the system generated scenario is randomly injected or is adaptively injected based on learning needs of a user as determined by the aircraft training system.

31. The method of embodiment 27 which further comprises introducing one or more variables for the user to dynamically react to during the running of the scenario.

32. The method of embodiment 31 wherein the one or more introduced variables comprise an environmental condition, a flight parameter, an aircraft configuration, a system issue, a failure issue, an air traffic issue, a runway issue, or any combination thereof.

33. The method of embodiment 31 wherein the one or more introduced variables are randomly generated, user generated, system generated, instructor generated, or generated by adaptive algorithms based on user performance and microstate measurements.

34. The method of embodiment 31 wherein the one or more introduced variables are based on learning needs of a user to increase or decrease the difficulty of the task, introduce variability into the task, change user expectations of the task, or any combination thereof.

35. The method of embodiment 27 which further comprises controlling at least a portion of the scenario by an instructor during the running of the scenario or after the running of the scenario.

36. The method of embodiment 31 which further comprises controlling at least a portion of the one or more introduced variables by an instructor during the running of the scenario or after the running of the scenario.

37. The method of embodiment 27 wherein the one or more introduced variables comprises a non-normal event introduced at a selected flight parameter and a selected flight-phase wherein each selection is (i) random, (ii) instructor-defined, (iii) schedule-based, (iv) machine learning based adaptive, or (v) any combination thereof.

38. The method of embodiment 27 which further comprises pausing, accelerating, or decelerating a scenario until a user interaction matches a required interaction.

39. A method of training a pilot comprising:
(1) providing a user with a mobile device selected from a virtual reality headset, a laptop computer, a tablet computer, or a mobile phone;
wherein the mobile device comprises a virtual flight deck display, a user interface, a processor, and an aircraft training system;
wherein the aircraft training system comprises pre-programmed sequences for pre-flight, taxi, and in-inflight normal and non-normal scenarios;
(2) running a scenario and analyzing data relating to the user's eye movement, hand movement, headset movement, controller movement, system interactions, or any combination thereof related to the scenario.

40. The method of embodiment 39 further comprising providing an evaluation to the user based on the analyzed data.

41. The method of embodiment 39 which further comprises introducing one or more variables for the user to dynamically react to during the running of the scenario wherein the one or more introduced variables are randomly generated, user generated, system generated, instructor generated, or generated by adaptive algorithms based on user performance and microstate measurements.

### Other Embodiments

As described above the systems and methods herein may comprise non-normal scenarios and/or one or more variables for the user to dynamically react to. A representative, non-limiting list of such non-normal scenario or variables that may be presented to the user is below.

### List of non-normal scenario or variables

### Environmental Conditions

Weather (wind, turbulence, precipitation, visibility, temperature)
Time of day and lighting

### Flight Parameters

Aircraft position, heading, speed, altitude
Flight phase (e.g., takeoff, cruise, approach)

### Aircraft Configuration

Weight and balance
Fuel load and distribution
Flaps, gear, and trim settings

### Systems and Automation

Electrical, hydraulic, pneumatic, and fuel systems
Autopilot and FMC state
Pressurization and environmental controls

### Failures and Malfunctions

Engine (failure, fire, surge)
Flight controls (jam, runaway trim))
Avionics and instruments
Fire and smoke scenarios
Cabin decompression

### Air Traffic and Navigation

TCAS traffic
ATC communications (scripted or manual)
Navigation aid availability or failure

### Runway and Airport Conditions

Surface condition (dry, wet, icy)
Airport lighting and signage
Obstacles and NOTAMs simulation

In some embodiments of the processes and systems described here an instructor may control aspects of the scenario and/or variable presented and be able to freeze, reposition, and/or reset a given scenario or presented variable. An instructor may also be enabled by the system to engage scenario or variable recording and/or playback as well as, accelerating, decelerating, or pausing the scenario or variable.

If desired, the digital environment during flow procedures, normal scenarios, and non-normal scenarios and variables may be configured such that a user or an instructor, or the system can modify the perceived difficulty of a task. Such modifications may include, but are not limited to, changes to the flight deck environment (e.g., lighting, emergency sounds, other audio distractions). Such modifications may also include interruptions during performance of a task/procedure. For example, in some embodiments the systems and processes may pose questions to the user, provide secondary tasks requiring an immediate response, or other such static, dynamic, or random injections/scenario as described above.

As described above a second, a third, or more user interfaces may be provided. In this manner flow procedures, scenarios, sequences, variables, and scenario modifications may be performed remotely through the additional separate user interfaces. Therefore, a second pilot and/or a flight instructor may readily modify the training tasks for the user or users.

Advantageously, in some embodiments psychological microstate detection methods can be used to estimate the perceived difficulty of a task. In this manner, rather than relying on an instructor to choose modifications to training tasks, a difficulty estimation modeling approach can be employed to select modifications to the training to enable a highly personalized training experience. This psychological microstate adaptive training approach may facilitate better training modifications by scaling the challenge of training tasks to the unique capabilities of the user. Such an adaptive learning approach may facilitate faster learning.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

We claim:

1. A method of training a pilot comprising:
providing a user with a mobile device selected from a virtual reality headset, a laptop computer, a tablet computer, or a mobile phone;
wherein the mobile device comprises a virtual flight deck display, a user interface, a processor, and an aircraft training system;
wherein the aircraft training system comprises pre-programmed sequences for pre-flight, taxi, and in-inflight normal and non-normal scenarios for two or more airlines, two or more types of aircraft, two or more crew member perspectives, two or more crew member's responsibilities, or any combination thereof;
prompting the user to select from a learn mode, a practice mode, or a validate mode;
prompting the user to select a scenario from the pre-programmed sequences for pre-flight, taxi, and in-inflight normal and non-normal scenarios;
running the selected scenario; and
collecting, storing, and analyzing data relating to the user's eye movement, hand movement, headset movement, controller movement, system interactions, or any combination thereof.

2. The method of claim 1 which further comprises providing an evaluation to the user based on the data.

3. The method of claim 2 which further comprises employing at least a portion of the data to measure one or more of a user's psychological microstates in real time.

4. The method of claim 3 wherein the one or more psychological microstates comprise fatigue, cognitive load, task focus, confusion, stress, or any combination thereof.

5. The method of claim 3 which further comprising employing one or more machine learning related approaches of preprocessing, multimodal data fusion, dimension reduction, feature extraction, ensemble learning, and model stacking to enhance predictive performance of microstate measurements, reliability of microstate measurements, predictive performance of user difficulty measurement, reliability user difficulty measurements, or any combination thereof.

6. A method of training a pilot comprising:
(1) providing a user with a mobile device selected from a virtual reality headset, a laptop computer, a tablet computer, or a mobile phone;
wherein the mobile device comprises a virtual flight deck display, a user interface, a processor, and an aircraft training system;
wherein the aircraft training system comprises pre-programmed sequences for pre- flight, taxi, and in-inflight normal and non-normal scenarios for two or more airlines, two or more types of aircraft, two or more crew member perspectives, two or more crew member's responsibilities, or any combination thereof;
(2) prompting the user to select a scenario or injecting a system generated scenario to the user;
(3) running the user selected or system generated scenario; and
(4) collecting, storing, and analyzing data relating to the user's eye movement, hand movement, headset movement, controller movement, system interactions, or any combination thereof related to the selected or injected scenario.

7. The method of claim 6 wherein the scenario selected by the user comprises pre-programmed sequences for pre-flight, taxi, and in-inflight normal and non-normal scenarios.

8. The method of claim 6 wherein the system generated scenario comprises pre-programmed sequences for pre-flight, taxi, and in-inflight normal and non-normal scenarios.

9. The method of claim 6 wherein the system generated scenario is randomly injected or is adaptively injected based on learning needs of a user as determined by the aircraft training system.

10. The method of claim 6 which further comprises introducing one or more variables for the user to dynamically react to during the running of the scenario.

11. The method of claim 10 wherein the one or more introduced variables comprise an environmental condition, a flight parameter, an aircraft configuration, a system issue, a failure issue, an air traffic issue, a runway issue, or any combination thereof.

12. The method of claim 10 wherein the one or more introduced variables are randomly generated, user generated, system generated, instructor generated, or generated by adaptive algorithms based on user performance and microstate measurements.

13. The method of claim 10 wherein the one or more introduced variables are based on learning needs of a user to increase or decrease the difficulty of the task, introduce variability into the task, change user expectations of the task, or any combination thereof.

14. The method of claim 6 which further comprises controlling at least a portion of the scenario by an instructor during the running of the scenario or after the running of the scenario.

15. The method of claim 10 which further comprises controlling at least a portion of the one or more introduced variables by an instructor during the running of the scenario or after the running of the scenario.

16. The method of claim 6 wherein the one or more introduced variables comprises a non-normal event introduced at a selected flight parameter and a selected flight-phase wherein each selection is (i) random, (ii) instructor-defined, (iii) schedule-based, (iv) machine learning based adaptive, or (v) any combination thereof.

17. The method of claim 6 which further comprises pausing, accelerating, or decelerating a scenario until a user interaction matches a required interaction.

18. A method of training a pilot comprising:
(1) providing a user with a mobile device selected from a virtual reality headset, a laptop computer, a tablet computer, or a mobile phone;
wherein the mobile device comprises a virtual flight deck display, a user interface, a processor, and an aircraft training system;
wherein the aircraft training system comprises pre-programmed sequences for pre-flight, taxi, and in-inflight normal and non-normal scenarios;
(2) running a scenario and analyzing data relating to the user's eye movement, hand movement, headset movement, controller movement, system interactions, or any combination thereof related to the scenario.

19. The method of claim 18 further comprising providing an evaluation to the user based on the analyzed data.

20. The method of claim 19 which further comprises introducing one or more variables for the user to dynamically react to during the running of the scenario wherein the one or more introduced variables are randomly generated, user generated, system generated, instructor generated, or generated by adaptive algorithms based on user performance and microstate measurements.
